(19) United States
(12) Patent Application Publication
(10) Pub. No.: US 2022/0078147 A1
(43) Pub. Date: Mar. 10, 2022

(54) NESTING THREADS AD INFINITUM

(71) Applicant: Gavin Burke, Oceanside, CA (US)

(72) Inventor: Gavin Burke, Oceanside, CA (US)

(21) Appl. No.: 17/466,333

(22) Filed: Sep. 3, 2021

Related U.S. Application Data
(60) Provisional application No. 63/074,613, filed on Sep. 4, 2020.

(51) Int. Cl. H04L 12/58; G06F 16/903

(52) U.S. Cl. CPC H04L 51/16; G06F 16/90335

(57) ABSTRACT

The preferred embodiments comprise computer-program instructions stored in an ad-infinitum-threading module of non-transient machine-readable memories which, upon effectuation via one or more data processors, execute operations to ad infinitum, upon generating an event on an indicium, traverse a document stack partitioned by thread depth; retrieve and display lineal user-generated messages; and retrieve and display identifying homophily-based information on user-generated messages of nested documents.

### CROSS REFERENCE TO RELATED APPLICATIONS

This patent application claims priority to a co-pending U.S. Provisional Application entitled “Method and System for Infinitely Thread-Able Comment Sections” Ser. No. 63/074,613 filed Sep. 4, 2020 the entire contents of which are hereby incorporated by reference.

### TECHNICAL FIELD

This patent application relates generally to computationally-implemented methods and systems for traversing threads and, more particularly, for traversing user-generated message threads partitioned in nested documents ad infinitum.

### BACKGROUND

Web 2.0 comprises user-generated message threads interpolated into digital media which suspend document-stack navigation and curtain homophily-based information on user-generated messages of nested documents. Suspending navigation, rather than partitioning nested documents for lineal threads, lineal user-generated messages are displayed on the same document as parent messages, cluttering and obscuring the space. Curtaining homophily-based information on user-generated messages of nested documents, users are oblivious to whether personally-relevant information exists on the nested documents and, accordingly, whether the nested documents are worth traversing to. In view of the foregoing, decluttered and revealing modes of traversing user-generated message threads are desirable.

### SUMMARY

The systems and methods described in the present patent application comprise computer-program instructions stored in an ad-infinitum-threading module of non-transient machine-readable memories which, upon effectuation via one or more data processors, execute operations to ad infinitum, upon generating an event on an indicium, traverse a document stack partitioned by thread depth; retrieve and display lineal user-generated messages; and retrieve and display identifying homophily-based information on user-generated messages of nested documents. The threads interpolate into digital media which may be user-generated (from a single or plurality of user(s)), from the World Wide Web, and/or from another information system. Generating threads therefrom, a nested document is instantiated for each thread, the interpolated threads and disparate media maintaining homophily-based information on user-generated messages of nested documents. As each thread maintains its own document, the preferred embodiments are especially advantageous in connection with the use of clients comprising small monitors and documents encapsulated in small windows.

### BRIEF DESCRIPTION OF THE DRAWINGS

FIG. 1 is a flow diagram of an example routine for traversing to a nested document and retrieving and displaying one or more lineal user-generated messages at a client.

FIG. 2 is a flow diagram of an example routine for inserting a lineal message into one or more non-transient machine-readable memories of a server computer system.

FIG. 3 is a directed acyclic rooted flowchart illustrating permutations of the foregoing example routines (i.e., unidirectional edges) and user-generated messages recursively partitioned in nested documents (i.e., nodes).

### DETAILED DESCRIPTION OF PREFERRED EMBODIMENTS

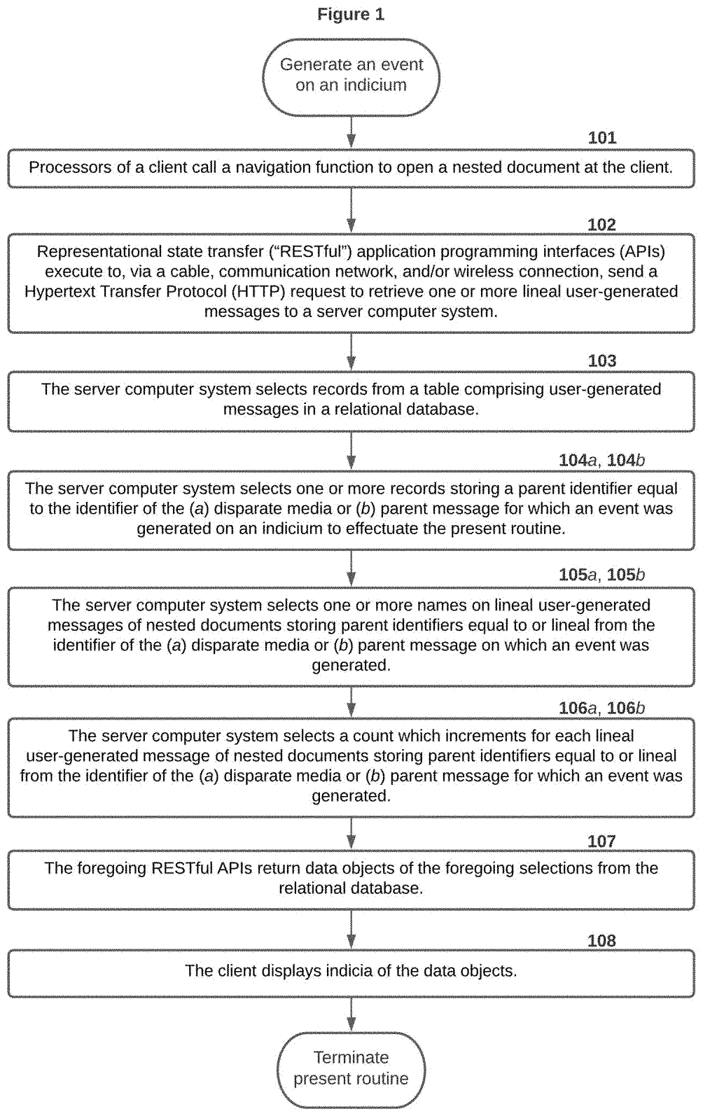

Referring now to FIG. 1 in more detail, the operations of the example routine effectuate client-side functions and database procedures stored in an ad-infinitum-threading module which navigate to a nested document at a client and request, select, retrieve, and display one or more user-generated messages lineal to a parent message or disparate media. The example routine is invoked via the generation of an event on an indicium on a computer-program product at a client. Such a computer-program product can be installed by any suitable software installation procedure, as is well known in the art. In a particular embodiment, at least a portion of the software instructions may also be downloaded as application software over a cable, communication network, and/or wireless connection from a server to a smartphone, laptop, personal computer, tablet, or other data-processing device.

Accordingly, upon generation of an event on an indicium, in step 101, processors of a client call a navigation function to open a nested document at the client; and, in step 102, representational state transfer (“RESTful”) application programming interfaces (APIs) execute to send, via a cable, communication network, and/or wireless connection, a Hypertext Transfer Protocol (HTTP) request to retrieve one or more lineal user-generated messages to a server computer system, the server comprising some combination of hardware and/or software capable of handling and executing the non-transient machine-readable instructions discussed herein. Although a RESTful API and HTTP are described herein, other techniques for sending a request to retrieve lineal threads from a server are possible.

Referring now to step 103, the server computer system selects records from a table comprising user-generated messages, which may be stored in a relational database. The preferred embodiment of the database is discussed herein as records in a table in a relational database merely for convenience. One skilled in the art will appreciate that, in alternative embodiments, the data could be stored in other types of data structures (e.g., as a hierarchical or object-oriented database). The one or more non-transient machine-readable memory components may include, e.g., read-only memory (ROM); random-access memory (RAM); storage including magnetic disk storage media; solid state drives (SSDs); optical storage media; flash memory devices; and/or any other mechanism for storing or transmitting information in a form readable by a machine (e.g., a computing device). The one or more data processors that execute the foregoing machine-readable instructions may be implemented, e.g., by a physical or virtual general-purpose computer having a central processor, memory, disk or other mass storage, communication interface(s), input/output (I/O) device(s), and/or other peripherals.

Narrowing the selection to immediate-child user-generated messages, the server computer system follows one of two execution paths to select one or more records storing a parent identifier equal to the identifier of the (a) disparate media or (b) parent message for which an event was generated on an indicium to effectuate the present routine (104a, 104b). To preview identifying information on lineal user-generated messages of nested documents and apprise the one or more users of the computer-program product of whether the nested documents are worth traversing to, the server computer system again follows one of two execution paths to select one or more names on lineal user-generated messages of nested documents storing parent identifiers equal to or lineal from the identifier of the (a) disparate media or (b) parent message on which an event was generated (105a, 105b). Enumerating the sum total of lineal messages, the server computer system yet again follows one of two execution paths to select a count which increments for each lineal user-generated message of nested documents storing parent identifiers equal to or lineal from the identifier of the (a) disparate media or (b) parent message for which an event was generated (105a, 105b). The foregoing RESTful APIs then return data objects of the foregoing selections from the relational database in step 107; and the client displays indicia of the data objects at 108.

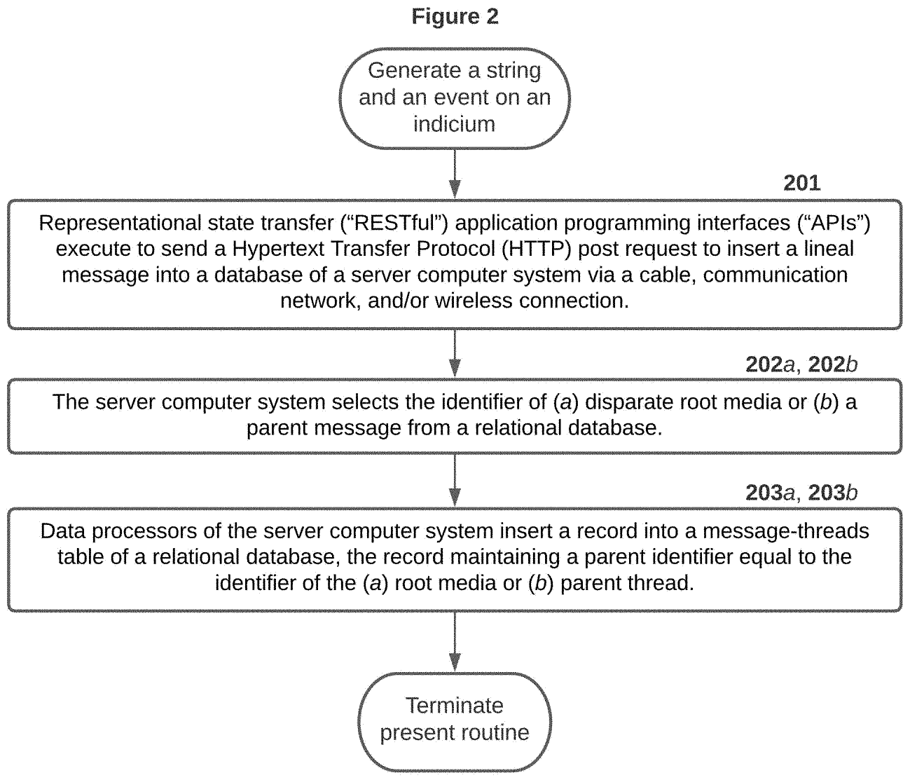

Referring now to FIG. 2 in more detail, the operations of the example routine effectuate client-side functions and database procedures stored in the aforesaid ad-infinitum-threading module which send a post request, select an identifier, and insert a record for a message upon one or more users of the computer-program product entering a string and generating an event on an indicium at a client. Accordingly, in step 201, representational state transfer (“RESTful”) application programming interfaces (“APIs”) execute to send a Hypertext Transfer Protocol (HTTP) post request to insert a lineal message into a database of a server computer system via a cable, communication network, and/or wireless connection; in step 202, the server computer system follows one of two execution paths to select the identifier of (a) disparate root media or (b) a parent message from a relational database; and, in step 203, ultimately terminating the present routine, data processors of the server computer system follow one of two execution paths to insert (b) or, more particularly, interpolate (a) a record into a message-threads table of a relational database, the record maintaining a parent identifier equal to the identifier of the (a) root media or (b) parent thread. The execution of the foregoing instructions instantiates a superlatively nested document or appends an existing one.

Referring back to FIG. 1 and FIG. 2, one of two execution paths are followed which originate directly from
disparate media (executing steps 101, 102, 103, 104a, 105a, 106a, 107, and 108 (referred to as “FIG. 1 path (a)”) or 201, 202a, and 203a (referred to as “FIG. 2 path (a)”)); or
a parent message (executing steps 101, 102, 103, 104b, 105b, 106b, 107, and 108 (referred to as “FIG. 1 path (a)”) or 201, 202b, and 203b (referred to as “FIG. 2 path (b)”)).

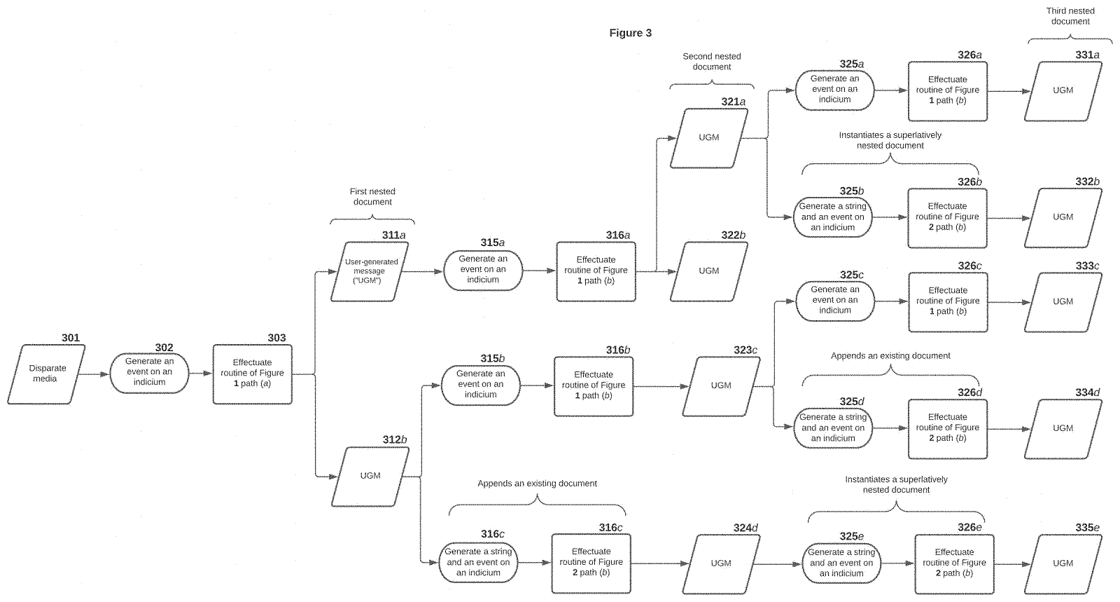

Referring now to FIG. 3 in more detail, the directed acyclic rooted flowchart illustrates permutations of the foregoing example routines (i.e., unidirectional edges) and user-generated messages recursively partitioned in nested documents (i.e., nodes). Originating at disparate media 301, a user generates an event on an indicium 302 to effectuate 303 the routine of FIG. 1 path (a), retrieving and displaying user-generated messages (UGMs) 311a, 312b on a first nested document. The process then proceeds towards generating an event on an indicium (315a, 315b) of a user-generated message which traverses the user to a thread on a nested document ad infinitum, effectuating the routine of FIG. 1 path (b) (316a, 316b). Generating a string and an event on an indicium 316c, the routine of FIG. 2 path (b) then effectuates. The result is traversing to or appending an existing document comprising user-generated messages 321a, 322b, 323c, and/or 324d on a second nested document. The process then further generates another string and/or an event on an indicium (325a, 325b, 325c, 325d, 325e) (by traversing to a nested document, instantiating a superlatively nested document, or appending an existing document), effectuating the routine of FIG. 1 path (b) or FIG. 2 path (b) (326a, 326b, 326c, 326d, 326e) (as appropriate) to view and/or produce the one or more user-generated messages 331a, 332b, 333c, 334d, and/or 335e.

### Implementation Options

It should be understood that the example embodiments described above may be implemented in many different ways. The embodiments may be implemented by data processors located within personal or laptop computers, servers, smartphones, tablets, mobile devices, embedded machines, and other computer systems. In some instances, the various “data processors” may each be implemented by a physical or virtual general-purpose computer having a central processor, memory, disk or other mass storage, communication interface(s), input/output (I/O) device(s), and other peripherals. The general-purpose computer is transformed into the processors and executes the methods described above, for example, by loading software instructions into the computer, and then causing execution of the instructions to carry out the functions described.

As is known in the art, such a computer may contain a system bus, where a bus is a set of hardware lines used for data transfer among the components of a computer or processing system. The bus or busses are essentially shared conduit(s) that connect different elements of the computer system (e.g., one or more central processing units, disks, various memories, input/output ports, network ports, etc.) that enables the transfer of information between the elements. One or more central processor units are attached to the system bus and provide for the execution of computer instructions. Also attached to the system bus are typically I/O device interfaces for connecting the disks, memories, and various input and output devices. Network interface(s) allow connections to various other devices attached to a network. One or more memories provide volatile and/or non-volatile storage for computer software instructions and data used to implement an embodiment. Disks or other mass storage provides non-volatile storage for computer software instructions and data used to implement, for example, the various procedures described herein.

Embodiments may therefore typically be implemented in hardware, custom designed semiconductor logic, Application Specific Integrated Circuits (ASICs), Field Programmable Gate Arrays (FPGAs), firmware, software, or any combination thereof.

In certain embodiments, the procedures, devices, and processes described herein are a computer-program product, including a computer-readable medium (e.g., a removable storage medium such as one or more DVD-ROMs, CD-ROMs, diskettes, tapes, etc.) that provides at least a portion of the software instructions for the system or the method. Such a computer-program product can be installed by any suitable software installation procedure, as is well known in the art. In another embodiment, at least a portion of the software instructions may also be downloaded as application software over a cable, communication network, and/or wireless connection from a server to a smartphone, laptop, personal computer, tablet, or other device.

Embodiments may also be implemented as instructions stored on a non-transient machine-readable medium, which may be read and executed by one or more procedures. A non-transient machine-readable medium may include any mechanism for storing or transmitting information in a form readable by a machine (e.g., a computing device). For example, a non-transient machine-readable medium may include read-only memory (ROM); random-access memory (RAM); storage including magnetic disk storage media; solid state drives; optical storage media; flash memory devices; and others.

Furthermore, firmware, software, routines, or instructions may be described herein as performing certain actions and/or functions. However, it should be appreciated that such descriptions contained herein are merely for convenience and that such actions in fact result from computing devices, processors, controllers, or other devices executing the firmware, software, routines, instructions, etc. It also should be understood that the block and network diagrams may include more or fewer elements, be arranged differently, or be represented differently. But it further should be understood that certain implementations may dictate the block and network diagrams and the number of block and network diagrams illustrating the execution of the embodiments be implemented in a particular way.

Accordingly, further embodiments may also be implemented in a variety of computer architectures, physical, virtual, cloud computers, and/or some combination thereof, and thus the computer systems described herein are intended for purposes of illustration only and not as a limitation of the embodiments.

The above description has particularly shown and described example embodiments. However, it will be understood by those skilled in the art that various changes in form and details may be made therein without departing from the legal scope of this patent as encompassed by the appended claims.

1. One or more non-transient machine-readable storage mediums comprising computer-program instructions which, upon effectuation via one or more processors of a client, execute operations to recursively retrieve and display one or more lineal user-generated messages on nested documents originating from disparate root media, the instructions comprising:
at a database:
using one or more non-transient machine-readable storage mediums:
maintaining a plurality of user-generated messages for viewing, upon request, by one or more users;
for each of the plurality of user-generated messages, maintaining a parent identifier; and
in response to the generation of an event on an indicium:
at one or more processors of a server computer system:
querying the plurality of lineal user-generated messages storing a parent identifier;
selecting one or more of the lineal user-generated messages storing a parent identifier equal to the identifier of disparate root media for which an event was generated on an indicium; and
at one or more clients:
by one or more processors of the one or more clients:
navigating from a root document comprising media disparate from user-generated messages to a nested document;
retrieving and displaying indicia of the one or more lineal user-generated messages on the nested document; and
at least twice therefrom:
in response to the generation of an event on an indicium:
at one or more processors of a server computer system:
querying the plurality of lineal user-generated messages storing a parent identifier;
selecting one or more of the lineal user-generated messages storing a parent identifier equal to the identifier of a parent message for which an event was generated on an indicium; and
at one or more clients:
by one or more processors of the one or more clients:
navigating to a nested document; and
retrieving and displaying indicia of the one or more lineal user-generated messages on the nested document.

2. The one or more non-transient machine-readable storage mediums as recited in claim 1, further comprising the storage of computer-program instructions which execute further operations comprising retrieving and displaying identifying information on one or more users with messages nested twice or more relative to the disparate root media.

3. The one or more non-transient machine-readable storage mediums as recited in claim 1, further comprising the storage of computer-program instructions which execute further operations comprising retrieving and displaying identifying information on one or more users with messages nested twice or more relative to another user-generated message thread.

4. The one or more non-transient machine-readable storage mediums as recited in claim 1, further comprising the storage of computer-program instructions which execute further operations comprising instantiating a superlatively nested document upon traversing at least twice to nested documents comprising user-generated messages; entering a string; and generating an event on an indicium.

5. The one or more non-transient machine-readable storage mediums as recited in claim 1, wherein computer-program instructions execute operations comprising, in response to the generation of an event on an indicium, navigating from a document comprising disparate root media to a nested document comprising one or more lineal user-generated messages; and, at least twice therefrom, navigating to a nested document also comprising one or more lineal user-generated messages.
